(19) United States
(12) Patent Application Publication
(10) Pub. No.: US 2018/0308118 A1
(43) Pub. Date: Oct. 25, 2018

(54) SYSTEMS AND METHODS FOR DETERMINING CUSTOMER PRIVILEGE LEVEL

(71) Applicant: Mastercard International Incorporated, Purchase, NY (US)

(72) Inventors: Srikant Biswal, Odisha (IN); Harinath Govindasamy, Mayiladuthurai (IN); Shashidevendra Prakash Goyal, Pune (IN); Vinodh Kumar Sampath, Tamil Nadu (IN); Soumya Ranjan Behera, Sambalpur (IN)

(73) Assignee: Mastercard International Incorporated, Purchase, NY (US)

(21) Appl. No.: 15/956,864

(22) Filed: Apr. 19, 2018

(30) Foreign Application Priority Data
Apr. 25, 2017 (SG) 10201703382Q

(51) Int. Cl. G06Q 30/02

(52) U.S. Cl. CPC G06Q 30/0231; G06Q 30/0224; G06Q 30/0215

(57) ABSTRACT

Systems and methods for determining a customer privilege level. The system includes: a processor module; a memory module including computer program code; the memory module and the computer program code configured to, with the processor module, cause the system at least to: receive (i) merchant-related data comprising a merchant identifier, and (ii) customer-related data comprising a customer identifier; determine a merchant score that is based on past transaction data associated with the merchant identifier and the customer identifier; receive an account-related score that is based on at least one attribute of an account associated with the customer identifier; and determine the customer privilege level based on the merchant score and the account-related score.

### CROSS-REFERENCE TO RELATED APPLICATIONS

This application claims the priority benefit of Singapore Application Serial No. 10201703382Q, filed Apr. 25, 2017, which is incorporated herein by reference in its entirety.

### FIELD OF INVENTION

The present invention relates broadly, but not exclusively, to systems and methods for determining a customer privilege level.

### BACKGROUND

Customer loyalty programs are offered by merchants with the intention of encouraging customers to continue to patronize or use the services of the merchant. Customer loyalty programs have varying features and rewards schemes. For example, customers may receive free merchandise, discounts, or special offers depending on their past purchases from the merchant.

More sophisticated customer loyalty programs may include a tiered system in which the customers that spend the most at the merchant enjoy the best rewards. To qualify for the next higher tier, the customer may need to spend a certain amount of money at the merchant within a specific period of time. Conversely, if a customer starts spending less at the merchant, he may be downgraded to a lower tier.

However, in most cases, a lot of resources are spent by merchants in administering the customer loyalty programs. For example, merchants have to constantly check the spending of customers to determine which tier they belong to. As a result, customers are typically upgraded to the next higher tier or downgraded to the next lower tier on an infrequent basis. On the other hand, if customers are dynamically upgraded/downgraded to the next higher/lower tier based on recent expenditure at a merchant, this may attract new customers to participate in the merchant's customer loyalty program.

Moreover, some customers may face difficulties in managing different loyalty programs for different merchants, especially merchants of the same merchant category. For example, different apparel retailers have their own customer loyalty program and customers may have difficulty managing the various customer loyalty programs.

A need therefore exists to provide systems and methods for determining a customer privilege level that seek to address at least some of the above problems.

### SUMMARY

According to a first aspect, there is provided a system for determining a customer privilege level, comprising: a processor module; a memory module including computer program code; the memory module and the computer program code configured to, with the processor module, cause the system at least to: receive (i) merchant-related data comprising a merchant identifier, and (ii) customer-related data comprising a customer identifier; determine a merchant score that is based on past transaction data associated with the merchant identifier and the customer identifier; receive an account-related score that is based on at least one attribute of an account associated with the customer identifier; and determine the customer privilege level based on the merchant score and the account-related score.

According to a second aspect, there is provided a method for determining a customer privilege level, comprising: receiving, at a merchant scoring module, (i) merchant-related data comprising a merchant identifier, and (ii) customer-related data comprising a customer identifier; determining, using the merchant scoring module, a merchant score that is based on past transaction data associated with the merchant identifier and the customer identifier; receiving, at the merchant scoring module, an account-related score that is based on at least one attribute of an account associated with the customer identifier; and determining, using the merchant scoring module, the customer privilege level based on the merchant score and the account-related score.

According to a third aspect, there is provided a system for determining a customer privilege level, comprising: a processor module; a memory module including computer program code; the memory module and the computer program code configured to, with the processor module, cause the system at least to: receive an account identifier; retrieve, from a database that is in communication with the system, at least one attribute of an account that is associated with the account identifier; and determine an account-related score that is based on the at least one attribute of the account, wherein the attribute of the account comprises: (i) an account fraud score, (ii) an account hierarchy score or (iii) an account transaction history, and wherein the account-related score is used to determine the customer privilege level.

According to a fourth aspect, there is provided a method for determining a customer privilege level, comprising: receiving, at an account scoring module, an account identifier; retrieving, from a database, at least one attribute of an account that is associated with the account identifier; and determining, using the account scoring module, an account-related score that is based on the at least one attribute of the account, wherein the attribute of the account comprises: (i) an account fraud score, (ii) an account hierarchy score or (iii) an account transaction history, and wherein the account-related score is used to determine the customer privilege level.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 is a schematic diagram illustrating flow of information between various entities during a method for determining a customer privilege level, according to an example embodiment;

FIG. 2 shows a schematic of a system for determining a customer privilege level, according to an example embodiment;

FIG. 3 shows a flow chart illustrating a method for determining a customer privilege level, according to an example embodiment;

FIG. 4 shows a schematic of a system for determining a customer privilege level, according to an example embodiment;

FIG. 5 shows a flow chart illustrating a method 500 for determining a customer privilege level, according to an example embodiment; and

FIG. 6 shows a schematic diagram of a computer system suitable for use in executing one or more steps of the methods for determining a customer privilege level according to example embodiments.

### DETAILED DESCRIPTION

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Embodiments relate to systems and methods for determining a customer privilege level associated with a tiered customer loyalty program. The customer privilege level is automatically and dynamically determined based on two components—a merchant score and an account-related score. The merchant score relates to past transactions made by a customer at the merchant and the account-related score is based on attributes of a payment card belonging to the customer. The attributes include past transactions made by a customer using the payment card, fraudulent transactions involving the payment card, type of payment card (e.g. credit card, debit card) and class of payment card (e.g. “platinum card”, “black card”, “gold card”, etc.). The merchant score and account-related score are regularly calculated and an increase or decrease in a total of the two scores results in a corresponding change in the customer privilege level. In this manner, customers can be upgraded to the next higher privilege level or downgraded to the next lower privilege level on a frequent basis due to, e.g. recent expenditure at a particular merchant. This may attract new customers to participate in the merchant's customer loyalty program. Dynamic determining of the customer privilege level motivates users to shop more and results in a win-win scenario for both the customers and the merchant.

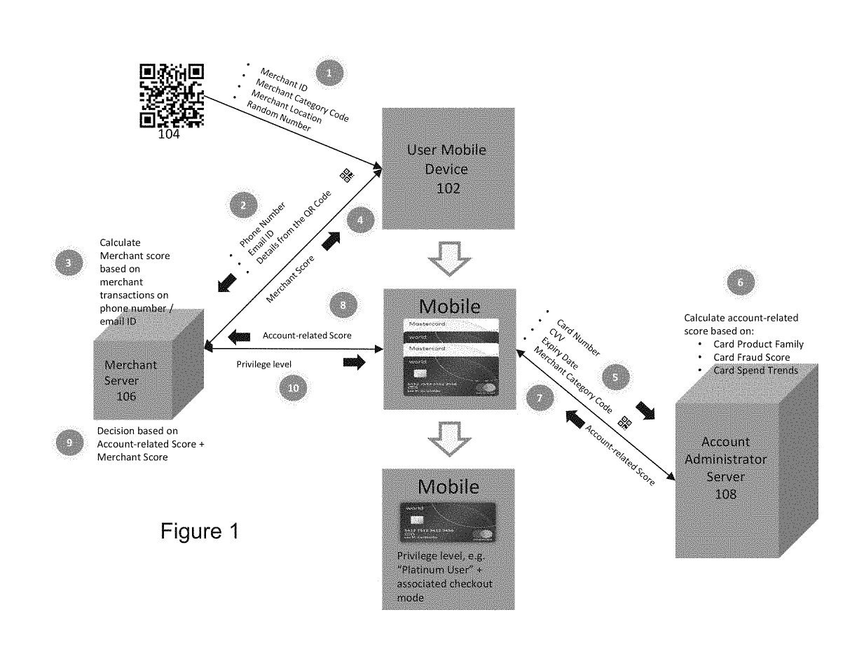

FIG. 1 is a schematic diagram illustrating flow of information between various entities during a method for determining a customer privilege level, according to an example embodiment.

At step 1, a customer visits a merchant's physical store and uses his mobile device 102 to scan a machine-readable code (e.g. a QR code 104). The machine-readable code may be displayed within the merchant's premises. For example, the machine-readable code may be displayed on a computer monitor that is placed near the entrance of the merchant's store. The machine-readable code can be encoded with one or more of the following information: (i) a unique merchant identity (Merchant ID), (ii) a Merchant Category Code (MCC), (iii) data relating to a location of the merchant's store (Location ID), (iv) a Merchant Uniform Resource Locator (URL), and (v) a random number. The Merchant ID, MCC, Location ID and Merchant URL are static parameters while the random number is a dynamic parameter.

The random number is used to keep track of utilized sessions as the number changes periodically (e.g. every 60 seconds). In this manner, the random number prevents duplication of a machine-readable code. The URL provides a link for customers to connect to a merchant server 106.

At step 2, some of the information captured from the machine-readable code by the user mobile device 102 is transmitted to the merchant server 106. In addition, other data such as unique user identifiers (e.g. user's phone number, email address) is transmitted from the user mobile device 102 to the merchant server 106. The unique user identifiers may be pre-registered with the merchant.

At step 3, the merchant server 106 checks the validity of the machine-readable code by verifying whether the random number encoded on the machine-readable code is in sync with (i.e. matches) a reference random number generated by the merchant server 106. The reference random number and the random number that is encoded on the machine-readable code can be generated using a pre-defined algorithm, e.g. Yarrow algorithm. The merchant server 106 may also check whether other details are valid (e.g. the MCC corresponds with the Merchant ID). If the machine-readable code and other details are valid, the customer is connected to the merchant server 106.

The merchant server 106 is connected to a database that stores data relating to previous transactions involving the merchant and its customers. The merchant server 106 retrieves data relating to previous transactions between the customer (identified via the unique user identifier(s)) and the merchant from the database. The merchant server 106 is configured to determine a “merchant score” based on the retrieved data relating to previous transactions between the customer and the merchant. The “merchant score” may be further determined based on other factors, such as type of products purchased from the merchant, how long the customer has been a loyal customer, etc.

After the “merchant score” is determined by the merchant server 106, the “merchant score” is transmitted to the user mobile device 102 at step 4.

The user mobile device 102, with a mobile wallet application installed thereon, displays a list of payment cards registered with the mobile wallet. The user selects the desired payment card(s), and at step 5, the desired card's details (such as card number, card verification value (CVV), expiry date, etc.) and the Merchant Category Code (encoded on the QR code) are transmitted to an account administrator server 108. The account administrator server 108 is typically administered by a financial institution associated with the payment card. For example, the financial institution can be an issuer bank, acquirer bank or payment network (e.g. MasterCard).

At step 6, the account administrator server 108 determines an “account-related score” based attributes of the desired payment card. The attributes include (i) past transactions made by a customer using the payment card, (ii) fraudulent transactions involving the payment card, (iii) type of payment card (e.g. credit card, debit card) and (iv) class of payment card (e.g. “platinum card”, “black card”, “gold card”, etc.). The user can select more than one payment card registered with the mobile wallet and the account-related score can be determined for each of the selected cards. Alternatively or in addition, the account-related score can be automatically determined for all payment cards registered with the mobile wallet as long as access is granted.

The past transactions made by the customer using the payment card include data such as a total amount of purchases, a frequency of purchases by the customer, and a merchant category code associated with the purchases. For example, if a customer visits an apparel merchant (at step 1), the relevant Merchant Category Code (MCC) is transmitted at step 5 and in one embodiment, only past spends on apparel by the customer using the payment card are considered when determining the account-related score. The more the customer spends in that category, the higher the account-related score.

An absence or presence of fraudulent transactions involving the payment card affects the account-related score. To achieve a high account-related score, there should be an absence of fraudulent transactions.

The type of payment card (e.g. credit card, debit card) and/or class of payment card (e.g. “platinum card”, “black card”, “gold card”, etc.) may determine the account-related score. For example, a more prestigious and exclusive credit card may result in a higher account-related score compared to a less prestigious debit card.

At step 7, the account-related score determined by the account administrator server 108 is transmitted to the user mobile device 102. The account-related score may be transmitted to the user mobile device 102 in response to a request by the user mobile device 102 (e.g. during first time use). Alternatively, the account-related score may be pushed to the user mobile device 102 at pre-determined times.

At step 8, the account-related score is transmitted from the user mobile device 102 to the merchant server 106. At step 9, the merchant server 106 determines a combined score based on the merchant score and the account-related score. The combined score can be a simple summation of the merchant score and the account-related score. The combined score determines the customer privilege level (e.g. platinum member, gold member, silver member, etc.).

At step 10, the customer privilege level determined by the merchant server 106 is transmitted to the user mobile device 102. The user mobile device 102 displays the determined customer privilege level and the customer can enjoy the rewards and benefits associated with the dynamically determined customer privilege level. For example, if a first user is determined to have the privilege of scanning products and doing automatic checkout by making online payment then that workflow is activated in the mobile application and step by step guidance is provided to the first user using the mobile application. If it is determined that a second user does not have the privilege then the mobile application of the second user either does not show automatic checkout option or shows it in disabled mode. However, the mobile application indicates to the second user the options determined for the second user. Determining and enabling the option in real time reduces the burden on the users to remember what privileges are available to them. In addition, dynamic determining motivates users to shop more and results in win-win scenario for both the users and the merchant. The step by step guidance further ensures that user experience is smooth. In some embodiments, if more than one checkout option is available then the user can select one out of them. In some embodiments, based on traffic in the store the merchant can customize the checkout experience to manager traffic in the store. For example, if the merchant server 106 monitors and determines that a threshold number of users have chosen gold checkout option but very few have chosen silver checkout option then the merchant server 106 may provide silver checkout option to further users who qualify for gold checkout and disable gold checkout option for such users.

For example, at a supermarket, a customer with a highest customer privilege level (“platinum member”) can join an express checkout queue and enjoy special discounts. On the other hand, a customer with a lower customer privilege level (e.g. “gold member”) is not entitled to join the express checkout queue and is given less discounts than the platinum member. However, if the gold member spends a significant amount on an occasion, he may be dynamically assigned a higher customer privilege level during his next visit. Conversely, if the platinum member shops less frequently at the merchant, he may be dynamically assigned a lower customer privilege level during his subsequent visit.

In an implementation, a particular customer privilege level can be tied to a certain checkout mode. For example, for the highest customer privilege level (“platinum”), the corresponding platinum checkout mode allows platinum members to scan a barcode of a product that they wish to purchase from the merchant. The details encoded on the barcode can be sent to a payment server module to retrieve the price of that particular product and eventually all the products are added to a checkout list. An invoice can be generated for the scanned items on completion of shopping. The platinum member can pay for all items using a digital wallet or use a self-checkout kiosk at the merchant's store. The self-checkout kiosk is capable of reading payment data from a mobile device with the digital wallet installed thereon, and payment can be done using the digital wallet application (i.e. card-not-present transaction) or a transaction using a physical payment card. After payment, a merchant's order ID is generated which is verified at the exit of the merchant store to ensure payment is made. The digital invoice can be saved in the digital wallet application. Platinum members are able to select the checkout options available Gold and Silver members which are described in more detail below.

Gold members are eligible for self-scan of products as described above for Platinum members. However, the gold checkout mode involves a manual check by the merchant's staff during payment. Nonetheless, Gold members can use their mobile device with the digital wallet installed thereon to transmit the payment information to the checkout kiosk. Gold members are able to select the checkout options available Silver members but not Platinum members.

Silver members are entry level members with the potential of becoming Gold and Platinum members. At this level they are not able to self-scan or self-checkout. Checkout is done with cashiers at physical point-of-sale terminals. In other words, Platinum and Gold members are able to enjoy a seamless checkout experience while Silver members have to go through a traditional form of checkout. It will be appreciated that the checkout experience described above can be extended to industries such as Airlines, Hospitality, etc.

Based on the dynamically determined customer privilege level, the associated checkout mode can be automatically activated for the customer and notified on the user's mobile device. For example, for a platinum member, the platinum checkout mode is automatically activated while the gold and silver checkout modes are automatically disabled though a mobile application installed on the user's mobile device.

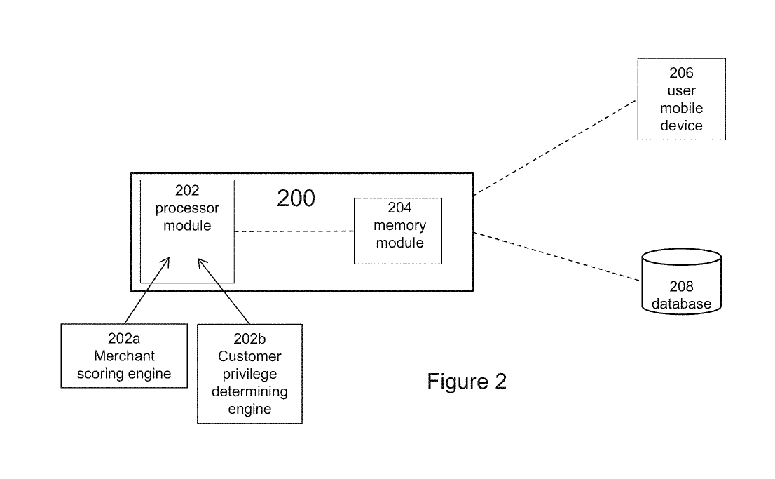

FIG. 2 shows a schematic of a system 200 for determining a customer privilege level, according to an example embodiment. The system 200 is functionally similar to the above-described merchant server 106. The system 200 includes a processor module 202 and a memory module 204. The memory module 204 includes computer program code and the memory module 204 is configured to, with the processor module 202, cause the system 200 at least to execute the following steps (in no particular order):
a. receive merchant-related data including a merchant identifier;
b. receive customer-related data including a customer identifier;
c. determine a merchant score that is based on past transaction data associated with the merchant identifier and the customer identifier;
d. receive an account-related score that is based on at least one attribute of an account associated with the customer identifier; and
e. determine the customer privilege level based on the merchant score and the account-related score.

The merchant-related data, customer-related data and/or account-related score may be received from a user mobile device 206 that is in communication with the system 200. The customer privilege level can be transmitted to the user mobile device 206.

In an implementation, the processor module 202 may include a merchant scoring engine 202a that is configured to determine the merchant score which is based on past transaction data associated with the merchant identifier and the customer identifier. The processor module 202 may also include a customer privilege determining engine 202b that is configured to determine the customer privilege level based on the merchant score and the account-related score.

The past transaction data associated with the merchant identifier and the customer identifier includes at least one of: a total amount of purchases by a customer associated with the customer identifier from a merchant associated with the merchant identifier; and a frequency of purchases by the customer from the merchant. The past transaction data can be stored in the memory module 204 or in an external database 208. Accordingly, the system 200 can retrieve the past transaction data associated with the merchant identifier and the customer identifier from memory module 204 or the database 208 that is in communication with the system 200.

In an implementation, the system 200 is further caused to: receive a dynamic time-based code from the user mobile device 206; and verify a validity of the dynamic time-based code. The system is caused to determine the merchant score (i.e. step c) on a condition that the validity of the dynamic time-based code is positively verified. The dynamic time-based code is a random number that changes after a pre-determined time interval. The validity of the dynamic time-based code that is received is verified by comparing to a reference dynamic time-based code. The dynamic time-based code is positively verified if there is a match.

Besides the merchant identifier, the merchant-related data may include merchant location data (e.g. physical address of the merchant). In such a case, the past transaction data is further associated with the merchant location data. In this manner, the merchant score is determined based past transaction data related only to transactions performed at one or more selected physical stores. For example, if the merchant location data corresponds to a merchant store in one city, the merchant score is determined based past transaction data associated with the merchant store in that city, not other cities.

In an implementation, the attribute of the account includes, but is not limited to: (i) an account fraud score, (ii) an account hierarchy score, and (iii) an account transaction history.

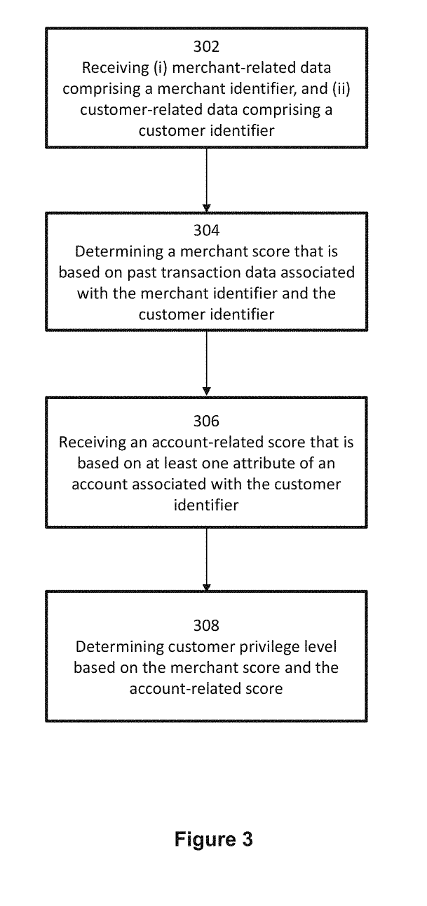

FIG. 3 shows a flow chart illustrating a method 300 for determining a customer privilege level, according to an example embodiment. The method 300 includes the following steps, in no particular order. At step 302, merchant-related data (including a merchant identifier) and customer-related data (including a customer identifier) are received at a merchant scoring module. The merchant scoring module is functionally similar to the above-described merchant server 106.

At step 304, a merchant score is determined using the merchant scoring module. The merchant score is based on past transaction data associated with the merchant identifier and the customer identifier. The past transaction data associated with the merchant identifier and the customer identifier includes at least one of: a total amount of purchases by a customer associated with the customer identifier from a merchant associated with the merchant identifier; and a frequency of purchases by the customer from the merchant. The past transaction data associated with the merchant identifier and the customer identifier may be retrieved from a database that is in communication with the merchant scoring module.

At step 306, an account-related score is received at the merchant scoring module. The account-related score is based on at least one attribute of an account associated with the customer identifier. The attribute of the account includes: (i) an account fraud score, (ii) an account hierarchy score and (iii) an account transaction history.

At step 308, the merchant scoring module is used to determine the customer privilege level based on the merchant score that is determined at step 304 and the account-related score that is received at step 306.

For added security, a dynamic time-based code is received at the merchant scoring module and the merchant scoring module is used to verify a validity of the dynamic time-based code. The step 304 of determining the merchant score is executed on a condition that the validity of the dynamic time-based code is positively verified.

In an implementation, the merchant-related data further includes merchant location data, and the past transaction data is further associated with the merchant location data. In this manner, the merchant score is determined based past transaction data related to transactions performed at one or more selected physical stores.

Subsequent to step 304, the method 300 may include the step of electronically communicating the determined customer privilege level and/or the checkout option associated with the determined customer privilege level to the user, e.g. via a mobile application installed on a mobile device or Short Message Service (SMS) text message, in real time.

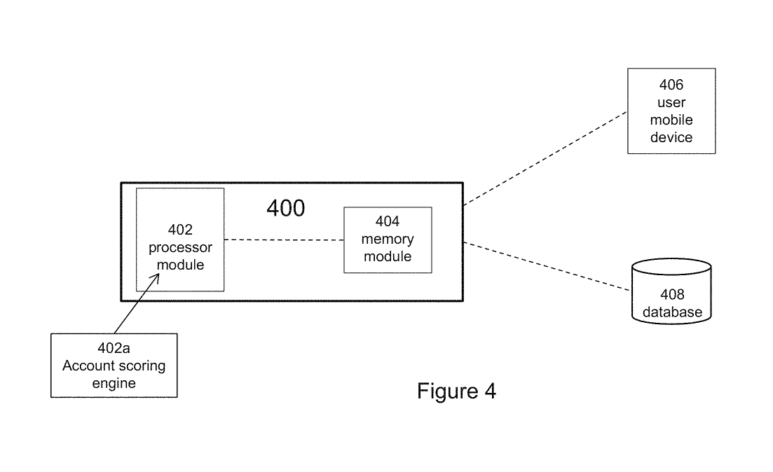

FIG. 4 shows a schematic of a system 400 for determining a customer privilege level, according to an example embodiment. The system 400 is functionally similar to the above-described account administrator server 108. The system 400 includes a processor module 402 and a memory module 404. The memory module 404 includes computer program code and the memory module 404 is configured to, with the processor module 402, cause the system 400 at least to execute the following steps (in no particular order):
a. receive an account identifier;
b. retrieve, from a database 408 that is in communication with the system 400, at least one attribute of an account that is associated with the account identifier; and
c. determine an account-related score that is based on the at least one attribute of the account. The account-related score is used to determine the customer privilege level.

The attribute of the account includes, but is not limited to: (i) an account fraud score, (ii) an account hierarchy score or (iii) an account transaction history.

The account transaction history includes at least one of: a total amount of purchases by a customer associated with the account identifier; and a frequency of purchases by the customer associated with the account identifier. The account transaction history may be stored in the database 408 in association with a relevant merchant category code. The system 400 is caused to receive a merchant category code, e.g. from a user mobile device 406. Thereafter, the system 400 is caused to determine the account-related score based on at least the account transaction history that is only associated with the received merchant category code. In an implementation, the processor module 402 may include an account scoring engine 402a that is configured to determine the account-related score based on at least one attribute of the account.

In an implementation, the system 400 is further caused to receive account authentication data and verify a validity of the account authentication data. The system 400 is caused to retrieve the at least one attribute of the account from the database on a condition that the validity of the account authentication data is positively verified. The account identifier includes a number of a payment card (e.g. Primary Account Number (PAN)) and the account authentication data includes a Card Verification Value (CVV) and/or an expiry date of the payment card.

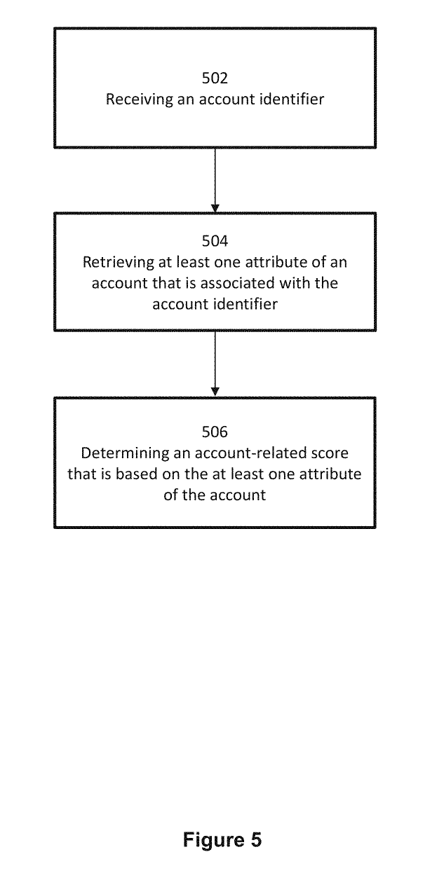

FIG. 5 shows a flow chart illustrating a method 500 for determining a customer privilege level, according to an example embodiment. The method 500 includes the following steps, in no particular order. At step 502, an account identifier is received at an account scoring module. The account scoring module is functionally similar to the above-described account administrator server 108.

At step 504, at least one attribute of an account that is associated with the account identifier is retrieved from a database. The attributes of the account include: (i) an account fraud score, (ii) an account hierarchy score or (iii) an account transaction history. The account transaction history includes at least one of: a total amount of purchases by a customer associated with the account identifier; and a frequency of purchases by the customer associated with the account identifier.

At step 506, an account-related score is determined using the account scoring module. The account-related score is based on the at least one attribute of the account. The account-related score is used to determine the customer privilege level.

In an implementation, the account transaction history is stored in the database in association with a relevant merchant category code. The method 500 further includes the following steps: receiving a merchant category code at the account scoring module; and using the account scoring module to determine the account-related score that is based on at least the account transaction history that is only associated with the received merchant category code.

For added security, the method 500 may further include the steps of: receiving account authentication data at the account scoring module; and using the account scoring module to verify a validity of the account authentication data. The step 504 of retrieving the at least one attribute of the account from the database is executed on a condition that the validity of the account authentication data is positively verified. The account identifier includes a number of a payment card (e.g. Primary Account Number (PAN)) and the account authentication data includes a Card Verification Value (CVV) and/or an expiry date of the payment card.

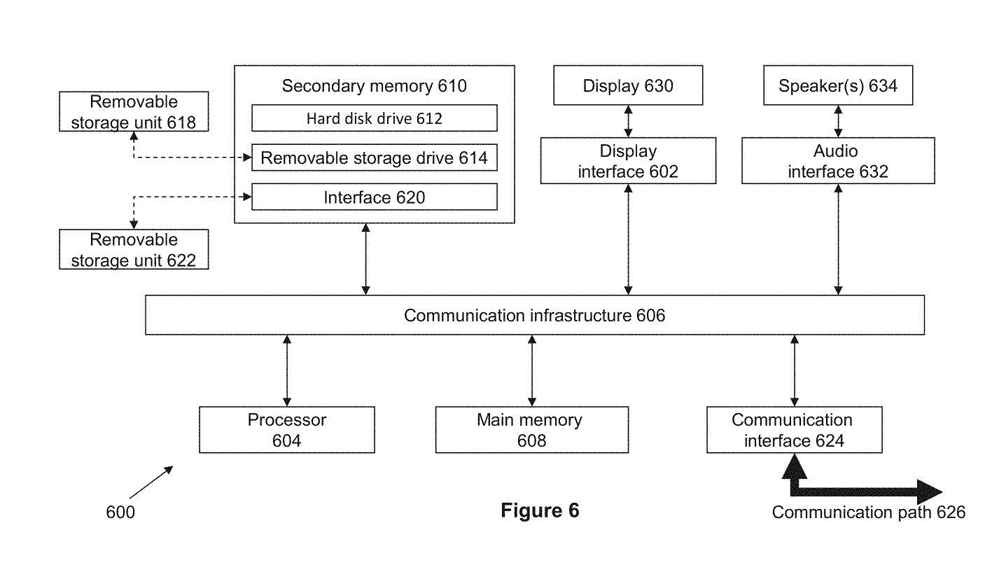

FIG. 6 shows a schematic diagram of a computer device/system 600 suitable for use in executing one or more steps of the above-described methods for determining a customer privilege level. One or more such computing devices 600 may be used to execute the above-described methods for determining a customer privilege level. In addition, one or more components of the computer system 600 may be used to realize the systems 200 or 400 for determining a customer privilege level. The following description of the computing device 600 is provided by way of example only and is not intended to be limiting.

As shown in FIG. 6, the example computing device 600 includes a processor 604 for executing software routines. Although a single processor is shown for the sake of clarity, the computing device 600 may also include a multi-processor system. The processor 604 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 610. The secondary memory 610 may include, for example, a hard disk drive 612 and/or a removable storage drive 614, which may include a magnetic tape drive, an optical disk drive, or the like. The removable storage drive 614 reads from and/or writes to a removable storage unit 618 in a well-known manner. The removable storage unit 618 may include a magnetic tape, optical disk, or the like, which is read by and written to by removable storage drive 614. As will be appreciated by persons skilled in the relevant art(s), the removable storage unit 618 includes a computer readable storage medium having stored therein computer executable program code instructions and/or data.

In an alternative implementation, the secondary memory 610 may additionally or alternatively include other similar means for allowing computer programs or other instructions to be loaded into the computing device 600. Such means can include, for example, a removable storage unit 622 and an interface 620. Examples of a removable storage unit 622 and interface 620 include a program cartridge and cartridge interface (such as that found in video game console devices), a removable memory chip (such as an EPROM or PROM) and associated socket, and other removable storage units 622 and interfaces 620 which allow software and data to be transferred from the removable storage unit 622 to the computer system 600.

The computing device 600 also includes at least one communication interface 624. The communication interface 624 allows software and data to be transferred between computing device 600 and external devices via a communication path 626. In various embodiments of the inventions, the communication interface 624 permits data to be transferred between the computing device 600 and a data communication network, such as a public data or private data communication network. The communication interface 624 may be used to exchange data between different computing devices 600 which such computing devices 600 form part an interconnected computer network. Examples of a communication interface 624 can include a modem, a network interface (such as an Ethernet card), a communication port, an antenna with associated circuitry and the like. The communication interface 624 may be wired or may be wireless. Software and data transferred via the communication interface 624 are in the form of signals which can be electronic, electromagnetic, optical or other signals capable of being received by communication interface 624. These signals are provided to the communication interface via the communication path 626.

As shown in FIG. 6, the computing device 600 further includes a display interface 602 which performs operations for rendering images to an associated display 630 and an audio interface 632 for performing operations for playing audio content via associated speaker(s) 634.

As used herein, the term “computer program product” may refer, in part, to removable storage unit 618, removable storage unit 622, a hard disk installed in hard disk drive 612, or a carrier wave carrying software over communication path 626 (wireless link or cable) to communication interface 624. Computer readable storage media refers to any non-transitory tangible storage medium that provides recorded instructions and/or data to the computing device 600 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 610. Computer programs can also be received via the communication interface 624. Such computer programs, when executed, enable the computing device 600 to perform one or more features of embodiments discussed herein. In various embodiments, the computer programs, when executed, enable the processor 604 to perform features of the above-described embodiments. Accordingly, such computer programs represent controllers of the computer system 600.

Software may be stored in a computer program product and loaded into the computing device 600 using the removable storage drive 614, the hard disk drive 612, or the interface 620. Alternatively, the computer program product may be downloaded to the computer system 600 over the communications path 626. The software, when executed by the processor 604, causes the computing device 600 to perform functions of embodiments described herein.

It is to be understood that the embodiment of FIG. 6 is presented merely by way of example. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A system for determining a customer privilege level, comprising:
a processor module;
a memory module including computer program code;
the memory module and the computer program code configured to, with the processor module, cause the system at least to:
receive (i) merchant-related data comprising a merchant identifier, and (ii) customer-related data comprising a customer identifier;
determine a merchant score that is based on past transaction data associated with the merchant identifier and the customer identifier;
receive an account-related score that is based on at least one attribute of an account associated with the customer identifier; and
determine the customer privilege level based on the merchant score and the account-related score.

2. The system according to claim 1, wherein the past transaction data associated with the merchant identifier and the customer identifier comprises at least one of:
a total amount of purchases by a customer associated with the customer identifier from a merchant associated with the merchant identifier; and
a frequency of purchases by the customer from the merchant.

3. The system according to claim 1, wherein the system is further caused to:
receive a dynamic time-based code; and
verify a validity of the dynamic time-based code,
wherein the system is caused to determine the merchant score on a condition that the validity of the dynamic time-based code is positively verified.

4. The system according to claim 1, wherein the merchant-related data further comprises merchant location data, and wherein the past transaction data is further associated with the merchant location data.

5. The system according to claim 1, wherein the system is further caused to:
retrieve, from a database that is in communication with the system, the past transaction data associated with the merchant identifier and the customer identifier; and
determine the merchant score based on the past transaction data that is retrieved from the database.

6. The system according to claim 1, wherein the attribute of the account comprises: (i) an account fraud score, (ii) an account hierarchy score, and (iii) an account transaction history.

7. A method for determining a customer privilege level, comprising:
receiving, at a merchant scoring module, (i) merchant-related data comprising a merchant identifier, and (ii) customer-related data comprising a customer identifier;
determining, using the merchant scoring module, a merchant score that is based on past transaction data associated with the merchant identifier and the customer identifier;
receiving, at the merchant scoring module, an account-related score that is based on at least one attribute of an account associated with the customer identifier; and
determining, using the merchant scoring module, the customer privilege level based on the merchant score and the account-related score.

8. The method according to claim 7, wherein the past transaction data associated with the merchant identifier and the customer identifier comprises at least one of:
a total amount of purchases by a customer associated with the customer identifier from a merchant associated with the merchant identifier; and
a frequency of purchases by the customer from the merchant.

9. The method according to claim 7, further comprising:
receiving, at the merchant scoring module, a dynamic time-based code; and
verifying, using the merchant scoring module, a validity of the dynamic time-based code, wherein the step of determining the merchant score is executed on a condition that the validity of the dynamic time-based code is positively verified.

10. The method according to claim 7, wherein the merchant-related data further comprises merchant location data, and wherein the past transaction data is further associated with the merchant location data.

11. The method according to claim 7, further comprising:
retrieving, from a database that is in communication with the merchant scoring module, the past transaction data associated with the merchant identifier and the customer identifier; and
determining, using the merchant scoring module, the merchant score based on the past transaction data retrieved from the database.

12. The method according to claim 7, wherein the attribute of the account comprises: (i) an account fraud score, (ii) an account hierarchy score and (iii) an account transaction history.

13. A system for determining a customer privilege level, comprising:
a processor module;
a memory module including computer program code;
the memory module and the computer program code configured to, with the processor module, cause the system at least to:
receive an account identifier;
retrieve, from a database that is in communication with the system, at least one attribute of an account that is associated with the account identifier; and
determine an account-related score that is based on the at least one attribute of the account,
wherein the attribute of the account comprises: (i) an account fraud score, (ii) an account hierarchy score or (iii) an account transaction history, and wherein the account-related score is used to determine the customer privilege level.

14. The system according to claim 13, wherein the account transaction history is stored in the database in association with a relevant merchant category code, and wherein the system is further caused to:
receive a merchant category code; and
determine the account-related score that is based on at least the account transaction history that is only associated with the received merchant category code.

15. The system according to claim 13, wherein the system is further caused to:
receive account authentication data; and
verify a validity of the account authentication data,
wherein the system is caused to retrieve the at least one attribute of the account from the database on a condition that the validity of the account authentication data is positively verified.

16. The system according to claim 13, wherein the account transaction history comprises at least one of:
a total amount of purchases by a customer associated with the account identifier; and
a frequency of purchases by the customer associated with the account identifier.
